(19) United States
(12) Patent Application Publication
(10) Pub. No.: US 2025/0153357 A1
(43) Pub. Date: May 15, 2025

(54) MOTION PATH GENERATING DEVICE AND MOTION PATH GENERATING METHOD

(71) Applicant: DENSO CORPORATION, Kariya-city (JP)

(72) Inventor: SHOTA ISHIKAWA, Kariya-city (JP)

(21) Appl. No.: 18/940,943

(22) Filed: Nov. 8, 2024

(30) Foreign Application Priority Data
Nov. 14, 2023 (JP) 2023-193983

(51) Int. Cl. B25J 9/16; B25J 9/00

(52) U.S. Cl. CPC B25J 9/1664; B25J 9/0087; B25J 9/163

(57) ABSTRACT

A processor includes a teaching motion storing unit in which teaching motions of robot are stored and a unit for storing constraint conditions in which constraint conditions including order constraints for robot motions are stored. A motion path generating device includes an initial path generating unit that generates motion paths for a plurality of robots, and a correcting unit that corrects motion start times of respective parts. The initial path generating unit determines motion start times of respective parts based on the teaching motions and the constraint conditions, and generates interference avoidance paths for the plurality of robots between two teaching motions. The correcting unit corrects the motion start times of the robots based on the generated motion path.

### CROSS REFERENCE TO RELATED APPLICATIONS

The present application is based on and claims the benefit of priority from Japanese Patent Application No. 2023-193983 filed in Japan filed on Nov. 14, 2023, the entire disclosure of the above application is incorporated herein by reference.

### TECHNICAL FIELD

The disclosure in this specification relates to a motion path generating device and a motion path generating method.

### BACKGROUND ART

A robot may repeat teaching motions which were taught previously by a user. In some cases, a plurality of robots moves simultaneously. If the robots just repeat the teaching motions respectively, the robots could collide with each other. Therefore, it is necessary to simulate motions of the robots and arrange the teaching motions to avoid collision among the robots. In the above aspects, or in other aspects not mentioned, there is a need for further improvements in a device and method for determining motion paths of a plurality of robots.

### SUMMARY

Disclosed aspects in this specification adopt different technical solutions from each other in order to achieve their respective objectives.

One of the disclosed motion path generating device for generating motion paths for a plurality of robots, comprising: a teaching motion storing unit that stores teaching motions for the plurality of robots; a constraint condition storing unit that stores constraint conditions including at least an order constraint of motions for the plurality of robots; an initial path generating unit that determines motion start times of the plurality of robots based on the teaching motions and the constraint conditions and generates motion paths for the plurality of robots by generating interference avoidance paths for the plurality of robots between two of the teaching motions; and a correcting unit that corrects the motion start times of the plurality of robots based on generated one of the motion paths.

One of the disclosed motion path generating method for generating motion paths for a plurality of robots, the method comprising: generating the motion paths for the plurality of robots by (i) determining motion start times for the plurality of robots based on teaching motions for the plurality of robots which are stored and constraint conditions including at least order constraints of motions for the plurality of robots which are stored and (ii) generating interference avoidance paths for the plurality of robots between two of the teaching motions; and correcting the motion start times for the plurality of robots based on the motion paths which are generated.

Thereby, it corrects the motion start time of the robot, which is determined based on the teaching motions and the constraint conditions, based on the motion path which is initially generated. Thereby, it is possible to eliminate unnecessary search for motion paths, and, e.g., it is possible to correct and improve an overall motion time for the plurality of robots. This device and method can generate motion paths by separately performing an initial generation of the motion paths and an optimization of the motion start times. As a result, this device and method contributes to reduce waiting times for respective robots and to reduce a time period required to generate appropriate motion paths.

### BRIEF DESCRIPTION OF DRAWINGS

The disclosure is further described with reference to the accompanying drawings in which:

FIG. 1 is a diagram showing a configuration of a motion path generating device according to a first embodiment;

FIG. 2 is a diagram explaining a configuration of a plurality of robots;

FIG. 3 is a diagram showing functions executed by a processor in FIG. 1;

FIG. 4 is a flowchart showing a process executed by the device of the first embodiment;

FIG. 5 is a diagram explaining the process of an initial path generating unit;

FIG. 6 is a diagram explaining a process performed by a correction unit;

FIG. 7 is a diagram showing functions executed by a processor according to a second embodiment;

FIG. 8 is a flowchart showing a process executed by the device of the second embodiment;

FIG. 9 is a diagram showing functions executed by a processor according to a third embodiment;

FIG. 10 is a flowchart showing a process executed by the device of the third embodiment;

FIG. 11 is a diagram showing functions executed by a processor according to a fourth embodiment;

FIG. 12 is a flowchart showing a process executed by the device of the fourth embodiment;

FIG. 13 is a diagram showing functions executed by a processor according to a fifth embodiment; and

FIG. 14 is a flowchart showing a process executed by the device of the fourth embodiment.

### DETAILED DESCRIPTION

JP2018-144223A discloses a method for teaching motions that avoid obstacles and prevent interference between robots in a case that a plurality of robots perform works in a common working area simultaneously. If passing areas of the robots intersect, this method additionally sets constraint conditions to prevent any of the robots from passing through. Furthermore, under the constraint conditions, instruction values are again generated for the robots to move while avoiding obstacles based on motion commands.

In JP2018-144223A, since a motion path that avoids obstacles based on the constraint conditions is generated, the motion path may be redundant, and a time required to determine the motion path may be longer. The method disclosed in JP2018-144223A may be improved with respect to determine a motion path in a short time period.

It is an object of the disclosure in this specification to provide a motion path generating device and a motion path generating method that can shorten the time required to determine motion path for a plurality robots.

Hereinafter, embodiments for implementing the present disclosure will be described referring to the drawings. In each embodiment, the same reference numerals may be given to parts corresponding to matters described in a preceding embodiment, and overlapping explanations may be omitted. When only a part of a configuration is described in an embodiment, the other preceding embodiments can be applied to the other parts of the configuration. It may be possible not only to combine parts which are explicitly described in the embodiments to be able to be combined specifically, but also to partially combine the embodiments without such explicit description unless there is a problem with the combination.

### First Embodiment

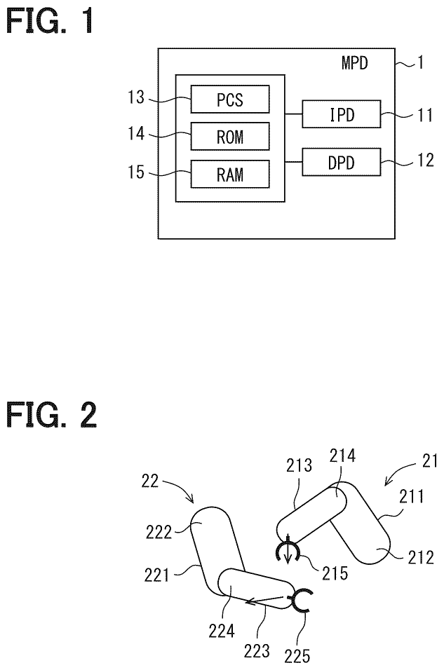

A first embodiment is described with reference to FIGS. 1-6. FIG. 1 is a diagram showing a configuration of a motion path generating device 1 according to the first embodiment. The motion path generating device 1 is a device that generates motion paths for respective robots with respect to a plurality of robots and surrounding obstacles. The obstacles are objects that impede motions of a first shaft unit, a second shaft unit, and a chuck unit of respective robots. The obstacles may include parts of the robots or objects located in a surrounding area other than the robot.

Each of the plurality of robots shown in FIG. 2 has two axes, two joints, and one chuck. The robot 21 includes a first shaft unit 211 and a second shaft unit 213, a first joint 212 and a second joint 214, and a chuck unit 215. The robot 22 includes a first shaft unit 221 and a second shaft unit 223, a first joint 222 and a second joint 224, and a chuck unit 225. The robot shown in the drawing has a simplified configuration for explaining the first embodiment. The robot may have three or more axes and joints. Each one of the plurality of robots are movable in the three dimensional space.

The first joint 212 of the robot 21 is provided at an end of the first shaft unit 211, and enables the first shaft unit 211 to rotate around a rotation axis perpendicular to the first shaft unit 211. The first shaft unit 211 is connected to, e.g., a base by the first joint 212 so as to be rotatable relative to the base. The base is installed, e.g., on a floor or an installation stand.

The second joint 214 of the robot 21 is provided at an end of the first shaft unit 211 on a side where the first joint 212 is not present. The second joint 214 connects the end of the first shaft unit 211 and the end of the second shaft unit 213. The second joint 214 enables the second shaft unit 213 to rotate relatively to the first shaft unit 211 around a rotation axis that is perpendicular to the first shaft unit 211 and the second shaft unit 213. The chuck unit 215 is provided at an end of the second shaft unit 213 on a side where the second joint 214 is not present. The chuck unit 215 is a pair of gripping members having an open end, and is capable of gripping an object such as a part. The chuck portion 215 is provided around an axis of the second shaft unit 213 in a rotatable manner. In FIG. 2, the first shaft unit 211 and the second shaft unit 213 has rod shapes. However, each of the first shaft unit 211 and the second shaft unit 213 do not have to have rod shapes, and may be variously changed according to an application of the robot 10.

An angular range in which the first shaft unit 211 can rotate relative to a base and a range in which the second shaft unit 213 can rotate relative to the first shaft unit 211 may be set based on a mechanical arrangement or an electrical arrangement. The configuration of the robot 22 is similar to that of the robot 21, and the above description of the robot 21 can be applied thereto. The first shaft unit 221 and the first joint 222 correspond to the first shaft unit 211 and the first joint 212. The second shaft unit 223 and the second joint 224 correspond to the second shaft unit 213 and the second joint 214. The chuck unit 225 corresponds to the chuck unit 215.

The motion path generating device (MPD) 1 includes an input device (IPD) 11, a display device (DPD) 12, a processor (PCS) 13, a ROM 14, and a RAM 15. The motion path generating device 1 having such a configuration may also be provided by a general-purpose computer. The motion path generating device 1 may also be provided by a virtual machine. The motion path generating device 1 may also be provided by a system including a computer and a server capable of communicating with the computer. The motion path generating device 1 may also be provided by a system including a computer and a cloud or a virtual machine capable of communicating with a computer.

The input device 11 has a keyboard or predetermined buttons, etc., and may be used to input structures of the robots described above, positions of obstacles, start points of motion paths, finish points of motion paths, and the like. Structures of the robot that can be input includes lengths and widths of the first axis unit and the second axis unit, a position of the first joint, and a relative position of the second joint with respect to the first shaft unit and the second shaft unit etc. The positions of the obstacles are defined by coordinates of spaces where obstacles exist. The display device 12 may display the motion paths, motion schedules, etc. of the robots generated by the motion path generating device 1.

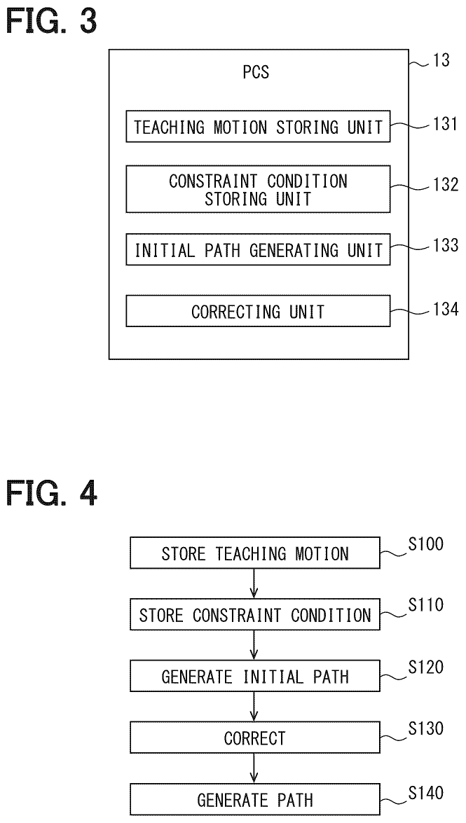

The ROM 14, which is a non-volatile storage medium, stores a motion path generating program executed by the processor 13. The processor 13 executes respective units shown in FIG. 3 by executing the motion path generating program stored in ROM 14 while the processor 13 uses a temporary storage function of RAM 15. Executing respective units shown in FIG. 3 by the processor 13 means executing the motion path generating method corresponding to the motion path generating program.

As shown in FIG. 3, the processor 13 includes a teaching motion storing unit 131, a constraint condition storing unit 132, an initial path generating unit 133, and a correcting unit 134. The process executed by these units are described with reference to the flowchart shown in FIG. 4.

The flowchart shown in FIG. 4 is started in response to a start operation of a user of the motion path generating device 1. A user using the motion path generating device 1 may include a person who is in a position where they can see the robots with the naked eye, and a person who is in a position where they can operate the robots remotely. By executing the flowchart shown in FIG. 4, a time period required to determine the motion path of the robot may be shortened, and an appropriate motion path may be generated.

The robots may move freely in a joint space contained in a three-dimensional space. The joint space is a coordinate space defined by a dimension of a number of joints possessed by the robots. An angle of the first joint can also be considered as an angle of the first shaft unit with respect to the base. An angle of the second joint can also be considered as an angle of the second joint with respect to the first joint. Since an attitude of the robot can be expressed by angles of joints, an attitude of the robot is determined by determining a coordinate in the joint space.

A step S100 (hereinafter, a word “step” may be omitted) is a process executed by the teaching motion storing unit 131. In the step S100, the teaching motion taught by a user is stored. For example, storing the teaching motion may be performed by a user by operating the input device 11. Storing the teaching motion may, e.g., be temporarily stored in RAM 15. The teaching motion may include storing of waypoints through which the robot must pass, and parameters or group of waypoints related to operations such as Pick, Place, and Screw tightening, etc. A group of waypoints is a set of stored way points.

The teaching motion includes control contents for the robots, working positions and postures, etc., given to the motion path generating device 1. The motion path generating method is a configuration in which the motion path generating program loads the teaching motions stored in advance, contrary a storing of the teaching motions in the step S100 may be not performed. Storing of the teaching motion may include an interpolation method for how the robots move in a section of the waypoints. In the step S100 or before the step S100, the user may use the input device 11 to input a structure of the robots, positions of obstacles, start points of the motion paths, end points of the motion paths, and the like.

A step S110 is a process executed by the constraint condition storing unit 132. In the step S110, it stores the constraint conditions including at least an order constraint of motions for respective robots. The order constraint is a constraint relating to an order of motions for respective robots, or a constraint relating to an order of motions among a plurality of robots. If the order constraints are stored, the processor 13 determines the motion timing of respective robots in accordance with the constraint and controls the motion of the robots. The constraint conditions include a link condition for smoothly linking the two teaching motions. The link conditions include passing through a via point, or smoothly linking teaching motions without interfering with obstacles, etc. The constraint conditions include determining which one of the teaching motions of the robots should be prioritized among a plurality of robots.

If this constraint conditions are not stored, the robots will not be prioritized and an order will be random. Furthermore, an order of the motions of the robots to which no constraint conditions are applied is determined so as to minimize the motion times by improving evaluation values such as the motion times.

For example, storing the constraint conditions may be performed by a user by operating the input device 11. Storing the constraint conditions may, e.g., be temporarily stored in RAM 15. The motion path generating method is a configuration in which the motion path generating program loads the constraint conditions stored in advance, contrary a storing of the constraint conditions in the step S110 may be not performed. In the step S110 or before the step S110, a user may input the above-mentioned constraint conditions by using the input device 11.

A step S120 is a process executed by the initial path generating unit 133. In the step S120, orders of the teaching motion of respective robots are extracted so that the teaching motions satisfy the constraint conditions including the order constraints. In the step S120, e.g., a simulator is used to determine whether or not the teaching motions cannot be executed simultaneously due to, e.g., interference among teaching motions of a plurality of robots. If the teaching motions cannot be performed simultaneously, a motion order in which the motions can be performed to satisfy the constraint conditions is determined, and the motion start time determined based on this motion order is set as an initial value. The motion start time is time when each robot starts moving, in other words, it is timing when each robot starts to move to perform a teaching motion.

Furthermore, in the step S120, non-interfering motion paths, where the plurality of robots do not collide, are generated between the two teaching motions. The non-interfering path is, e.g., a path that does not cause any collisions between a robot and surrounding objects or between a robot and a robot. The motion path generating device 1 has a map including non-interfering paths that are created in advance based on information such as self-interference of each robot, interference with surrounding equipment, and interference between robots. The processor 13 generate a motion path which does not interfere by performing a random search when searching the map. The processor 13 can perform path generation for the plurality of robots quickly by mapping non-interfering paths in advance.

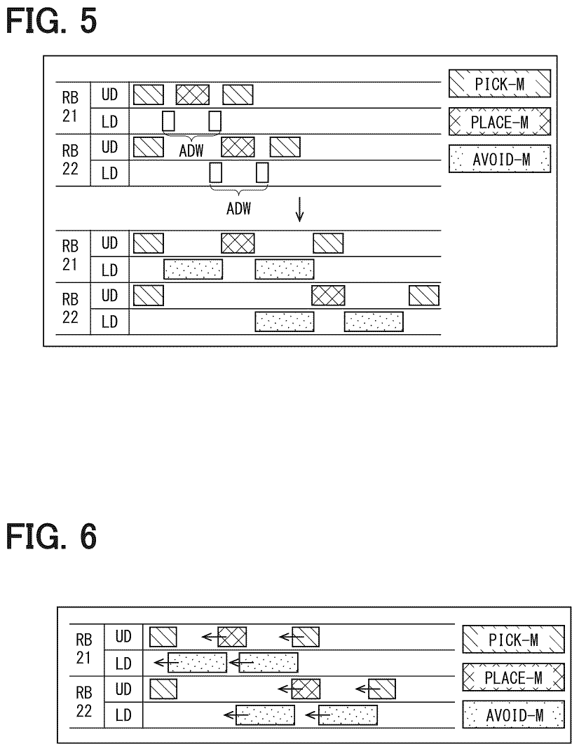

FIG. 5 shows an example of the process of the initial path generating unit and the process in the step S120. The example shown in FIG. 5 shows motions in up and down directions (UD) and motions in lateral directions (LD) of the robot 21 (RB21) and the robot 22 (RB22) for respective teaching motions. The example of the teaching motions for the robot are the PICK motion (PICK-M) for picking up a part and the PLACE motion (PLACE-M) for placing a part. A motion process shown on an upper stage of FIG. 5 shows a result of determining an order of the teaching motions based on the order constraints and determining the motion start times of respective motions. The motion process shown in the drawing includes an adjustment width (ADW) secured between the teaching motion and the teaching motion (which may be also called between the teaching motions). The adjustment width is an adjustable time with respect to the determined motion start time. Since the teaching motion alone does not include the motion time of the robot between the teaching motions, a motion path between the teaching motions is generated and the adjustable time is calculated. The processor 13 adjusts it by varying the motion start time of the teaching motion within a range of the adjustment width.

A motion process shown on a lower stage of FIG. 5 shows a results of generating interference avoidance motions (AVOID-M) between the teaching motion and the teaching motion in an order from a top of the teaching motions, and updating the motion start times in accordance with the interference avoidance motions. The processor 13 generates the interference avoidance paths for the plurality of robots between the two teaching motions, and generates motion paths for the plurality of robots.

A step S130 is a process executed by the correcting unit 134. In the step S130, it optimizes so as to shorten an overall motion time by placing a path added between the teaching motion and the teaching motion as an initial solution. In the step S130, a motion optimizing process is executed to optimize it as a whole by correcting the motions of respective robots. In the step S130, a motion start time of a robot is corrected so that the overall motion time for the plurality of robots is reduced. In the step S130, the robot action start times are corrected so as to improve the evaluation values for overall motions of the plurality of robots. The processor 13 may obtain a motion that at least satisfies a target evaluation value even if it is not an optimal solution by gradually improving executable motion using the correcting unit 134.

The processor 13 searches for a motion start time of the teaching motion within a range that satisfies the order constraint. Furthermore, the processor 13 also searches for a motion start time for moving the non-interfering path generated in the step S120. Furthermore, the processor 13 also calculates a range of motion start times that is likely to improve the evaluation values while satisfying the order constraint. The processor 13 searches for a motion start time that provides a better evaluation values within the range of the calculated motion start times. The processor 13 can minimize the overall motion time for the plurality of robots by searching for a motion start time that improves the evaluation value for the overall motions. The processor 13 searches for a motion start time that improves the evaluation value of the overall motions. Searching process that improves the evaluation values is, e.g., process for searching a motion start time so as to shorten a motion time for the overall motions. The processor 13 further evaluates evaluation values such as an energy consumption, movement amounts of respective joints, movement amounts of hands such as the chuck units, etc. by weighting them. Furthermore, as a search method, the processor 13 can utilize, e.g., a binary search if the evaluation value changes linearly, and can utilize Bayesian optimization if the evaluation value changes nonlinearly. The processor 13 may use an order of search which prioritizes a single robot over the plurality of robots, and may perform searches in an order from a shortest one of the motion start times to a longer one of the motion start times. Furthermore, if there are multiple adjustable motion start times, the processor 13 may perform searches in an order from a latest one of the motion start times to an earlier one of the motion start times, in a random order, or in a parallel order search.

FIG. 6 shows an example of the process of the correcting unit and the process in the step S130. The example shown in FIG. 6 shows that the motion start times for the teaching motions and the interference avoidance motions of the robot 21 and the robot 22 are modified from the example shown in FIG. 5. The processor 13 adjusts the motion start times of respective parts in a little by little manner rather than optimizing them all at once. The processor 13 determines the motion start times of respective parts while checking a shortening state of an overall motion time for the plurality of robots. In the example shown in FIG. 6, the motion start times for respective parts are changed, but the motion path is not changed from the motion path determined by the initial path generating unit 133.

The processor 13 performs controls to smoothly connect the teaching motion and the interference avoidance motion so that the respective robots are able to start next one of the teaching motions as soon as possible. For example, an amount of smooth connection is controlled when a position of a hand at waypoints falls within a specified distance range, or when a distance to an obstacle exceeds a certain distance. If two robots are waiting to avoid interference between them, there could be a motion start time during which no interference occurs even if one robot starts a motion before the other robot starts a motion. In this case, the processor 13 may optimize the motion start time little by little to an extent that the order constraint is satisfied and no interference occurs.

In a step S140, the motion start times corrected in the step S130 are used to generate motion paths for the plurality of robots. As described above, the processor 13 may provide motion paths for the plurality of robots that may shorten a time required to determine the motion paths.

Operations and effects of the motion path generating device 1 according to the first embodiment is described. The motion path generating device 1 is a device that generates motion paths for the plurality of robots. The motion path generating device 1 includes a teaching motion storing unit 131 in which teaching motions for the robots are stored, and a constraint condition storing unit 132 in which constraint conditions including at least an order constraint of the motion for the robots are stored. The motion path generating device 1 includes an initial path generating unit 133 that generates motion paths for a plurality of robots, and a correcting unit 134 that corrects motion start times of the robots. The initial path generating unit 133 determines motion start time of the robots based on the teaching motions and the constraint conditions, and generates interference avoidance paths for a plurality of robots between two teaching motions. The correcting unit 134 corrects the motion start times of the robots based on the motion paths which are generated.

The device corrects the motion start time, which is determined based on the teaching motions and the constraint conditions, based on the motion path which is initially generated. Thereby, it is possible to eliminate unnecessary search for motion paths. The device may be modified, e.g., to improve an overall motion time for a plurality of robots. This device and method can generate motion paths by separately performing an initial generation of the motion paths and an optimization of the motion start times. As a result, it is possible to reduce waiting times for respective robots and to reduce a time period required to generate appropriate motion paths. Furthermore, it is also possible to provide a device that can optimize the motion start times and generate the motion paths for a plurality of robots based on the corrected motion start times.

The motion path generating method includes determining the motion start times of the robots based on the teaching motions of the robots which are stored and the constraint conditions including at least the order constraint of the motions for the robots which are stored, and generating the motion paths for the plurality of robots by generating interference avoidance paths for the plurality of robots between the two teaching motions. The method further includes modifying a motion start time of the robot based on the motion path which is generated.

This method corrects the motion start times determined based on the teaching motions and the constraint conditions so as to improve an overall motion time for the plurality of robots based on the initially generated motion path. According to this method, it is possible to generate motion paths by separately performing an initial generation of the motion paths and an optimization of the motion start times. According to this order, it is possible to reduce waiting times for respective robots and to reduce a time period required to generate appropriate motion paths. Furthermore, it is also possible to provide a motion path generating method that can optimize the motion start times and generate the motion paths for a plurality of robots based on the corrected motion start times.

### Second Embodiment

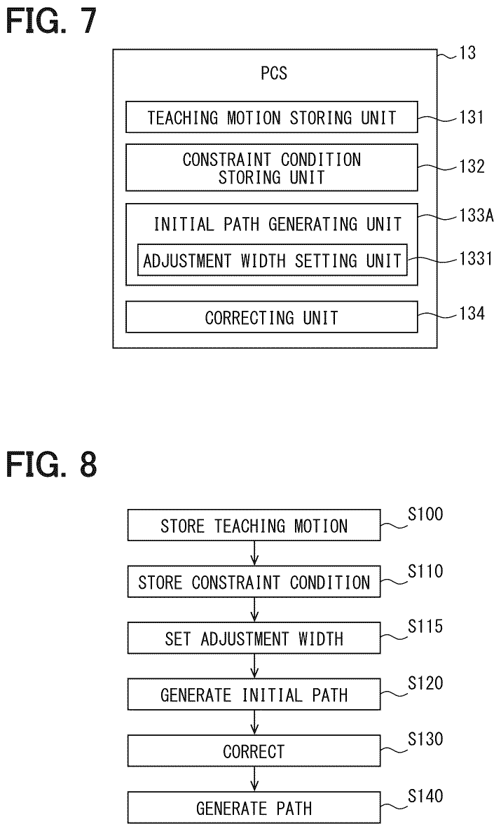

A second embodiment is described with reference to FIG. 7 and FIG. 8. The motion path generating device according to the second embodiment is described with reference to FIG. 7 and FIG. 8. Steps, configurations, actions, and effects not specifically described in the second embodiment are the same as those in the first embodiment, and only points different from the first embodiment will be described below.

The second embodiment differs from the first embodiment in that it includes an adjustment width setting unit 1331 and in that it includes a processing step S115. According to the flowchart shown in FIG. 8, except for a step S115, the same processes as those in the steps having the same reference numerals as those shown in FIG. 4 are performed.

The initial path generating unit 133A includes an adjustment width setting unit 1331. In the step S115, which is a process executed by the adjustment width setting unit 1331, an adjustment width of a motion start time that satisfies an order constraint at start and finish points that are targets of motion path generation is set before generating a motion path. The initial path generating unit 133A determines a safety distance among a plurality of robots based on a distance that the robot moves in a time period that is the adjustment width. The safety distance contributes to making it difficult for the robots to approach each other closer than a distance in which the robots can travel in the adjustable time. If there is an adjustment time for each of a plurality of robots, it is possible to adopt a method of setting the adjustment time for each of a plurality of robots or a method of setting a maximum or minimum adjustment time.

This safety distance is stored in the constraint condition storing unit 132 as one of the constraint conditions. The initial path generating unit 133A determines, in the step S120, the motion start times of the plurality of robots based on these constraint conditions.

The initial path generating unit 133A determines whether or not motion paths shifted by the adjustable time cause interference, when determining interference of motions between the robots during path generating process. If the motion paths interfere with each other, the initial path generating unit 133A generates a non-interfering path even if the motion start times are shifted within a range of the adjustable time.

According to the second embodiment, ensuring the safety distance between the plurality of robots is stored as a constraint condition in the constraint condition storing unit 132. This safety distance is determined based on the distance the robot moves within an adjustable time, which is the adjustment width for the determined motion start time. This makes it possible to generate a path that is less likely to cause interference even if a motion start time is shifted. In addition, it is possible to provide a highly safe motion path that makes it difficult for the robots to approach each other closer than a distance in which the robots can travel in the adjustable time. Furthermore, even if a motion start time is corrected by the correcting unit 134, it is possible to contribute minimizing the motion start time by generating a non-interfering path. Furthermore, it is possible to generate paths in which the robots are spatially spaced apart by taking into account a search range for a motion start time. A search range for a motion start time is a range defined by a minimum value and a maximum value. The minimum value is a later one of the earliest one of motion start times that satisfies constraints and a time when a motion previously performed by the same robot is finished. The maximum value is a motion start time when a robot performed motions in an order determined in an initial path planning.

The initial path generating unit 133A generates non-interfering paths for the plurality of robots based on an adjustable time, which is the adjustment width for the motion start time. This makes it possible to provide a motion path that prevents the robots from approaching closer to each other than a distance in which the robots can travel in the adjustable time, even if the motion start times differ.

### Third Embodiment

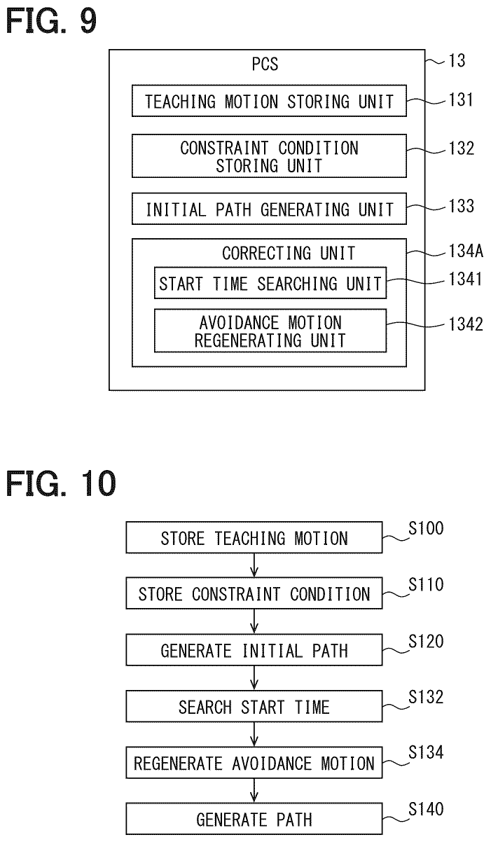

A third embodiment is described with reference to FIG. 9 and FIG. 10. The motion path generating device according to the third embodiment is described with reference to FIG. 9 and FIG. 10. Steps, configurations, actions, and effects not specifically described in the third embodiment are the same as those in the first embodiment, and only points different from the first embodiment will be described below.

The third embodiment differs from the first embodiment in that it includes a start time searching unit 1341 and an avoidance motion regenerating unit 1342, and in that it includes processing steps of S132 and S134. According to the flowchart shown in FIG. 10, the same processes as those in the steps having the same reference numerals shown in FIG. 4 are performed except for the steps S132 and S134.

The correcting unit 134A includes a start time searching unit 1341 and an avoidance motion regenerating unit 1342. In the step S132, which is processing executed by the start time searching unit 1341, a search is made for the start time of the teaching motion or the motion start time of the non-interfering path generated in the step S120 within a range that satisfies the order constraint. In the step S132, a range of motion start times that is likely to improve the evaluation values is calculated while satisfying the order constraint. In the step S132, a motion start time that improves the evaluation values is searched within the range of the motion start times. This evaluation values are the same as the evaluation values used in the first embodiment described above.

In the step S134, which is processing executed by the avoidance motion regenerating unit 1342, the interference avoidance motion is regenerated in response to the change to the motion start time which is searched. In the step S134, in relation to a changed one of the motion start time, if there is no interference at a start point but interference occurs between the robots in motions after the start point, an interference avoidance motion is regenerated. The avoidance motion regenerating unit 1342 regenerates the interference avoidance motion between the robots where interference occurs or for all the robots included in a section to be regenerated. Furthermore, if regenerating is performed only between robots where interference occurs, the paths of the other robots may not be changed and a determination as to whether or not interference occurs may be made when generating the paths in the step S140.

The avoidance motion regenerating unit 1342 regenerates interference avoidance motions based on an amount of change in the motion start time of the non-interfering path searched for by the start time search unit 1341. Therefore, it is possible to generate more appropriate interference avoidance motions, and this contributes to bring the motion start times earlier. Therefore, it is possible to reduce waiting times for respective robots and to reduce a time period required to generate appropriate motion paths.

The correcting unit 134A regenerates the motions for the plurality of robots by setting the motion start time for a specific robot to a fixed value. According to this, since the motion start time of a specific robot is fixed and the motion is regenerated, it is possible to reduce an amount of calculations, and reduce a time required to generate an appropriate motion path.

### Fourth Embodiment

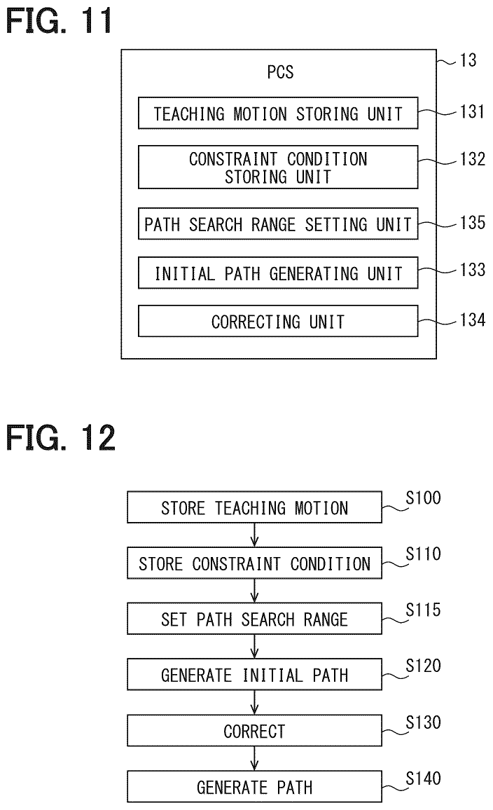

A fourth embodiment is described with reference to FIG. 11 and FIG. 12. The motion path generating device according to the fourth embodiment is described with reference to FIG. 11 and FIG. 12. Steps, configurations, actions, and effects not specifically described in the fourth embodiment are the same as those in the first embodiment, and only points different from the first embodiment will be described below.

The fourth embodiment differs from the first embodiment in that it includes a path search range setting unit 135 and in that it includes a processing step S1115. According to the flowchart shown in FIG. 12, the same processes as those in the steps having the same reference numerals shown in FIG. 4 are performed except for the step S115.

The PCS 13 includes the path search range setting unit 135. In the step S115, which is a process executed by the path search range setting unit 135, before generating a motion path, a threshold value for an evaluation value of the motion path to be generated is set. In the step S115, a motion path is searched within a range in which the evaluation values do not deteriorate in generating a motion path later. In this way, the path search range setting unit 135 sets the path search range. The processor 13 evaluates evaluation values such as an operation time, movement amounts of respective joints, movement amounts of hands such as the chuck units, etc. by weighting them.

Furthermore, the PCS 13 may process to update a setting value for the path search range before re-calculate the motion path by the correcting unit 134. As an example, the PCS 13 may set a path search range so that it reaches to an end point before a teaching motion of the other robot is completed. As an example, if a motion path is generated after adjusting a motion start time, the PCS 13 may set a previous motion time to set a path search range so that a motion time does not increase. As an example, the PCS 13 may set a relationship of arrival orders between the robots so that the constraint conditions relating to the motion order are satisfied.

The motion path generating device 1 includes a path search range setting unit 135 that searches a range of a motion path based on the evaluation values of the motion paths for a plurality of robots. The path search range setting unit 135 searches for motion paths for a plurality of robots so that the evaluation values of all robots to be controlled are equal to or less than the evaluation value of a specific robot.

This makes it possible to search for the motion paths of all robots to be controlled while securing the evaluation value of the robot that could be a bottleneck. In other words, the motion paths of all robots can be searched while the path of the bottleneck robot is appropriately secured, thereby optimizing an overall motion path.

If the evaluation value is a motion time, it is possible to provide a motion path that can optimize the overall motion time. In a process of generating motion paths for a plurality robots, the process could be possible to set a shortened time of a motion time for a bottleneck robot by slowing down a speed in a motion path of at least one of the robots. This makes it possible to search for a motion path while evaluating how slow it could be.

### Fifth Embodiment

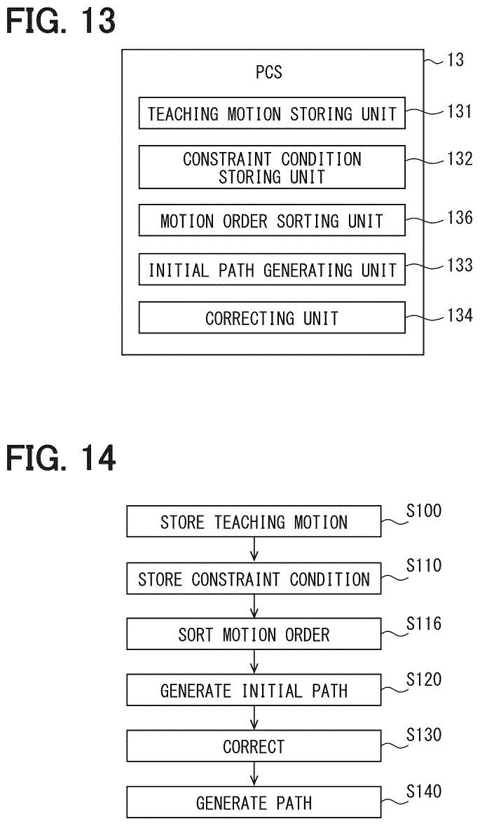

A fifth embodiment is described with reference to FIG. 13 and FIG. 14. The motion path generating device according to the fifth embodiment is described with reference to FIG. 13 and FIG. 14. Steps, configurations, actions, and effects not specifically described in the fifth embodiment are the same as those in the first embodiment, and only points different from the first embodiment will be described below.

The fifth embodiment differs from the first embodiment in that it includes a motion order sorting unit 136 and in that it includes a processing step S116. According to the flowchart shown in FIG. 14, the same processes as those in the steps having the same reference numerals shown in FIG. 4 are performed except for the step S116.

The PCS 13 includes the motion order sorting unit 136. A step S116, which is a process executed by the motion order sorting unit 136, performs a process of sorting the teaching motions for respective robots stored in chronological order so as to satisfy the order constraints. This makes it possible to extract the teaching motion and start and finish point information including a motion path start point and a motion path finish point that is used by the initial path generating unit 133. Furthermore, a section, e.g., where joint angles of the robots are different for an interference avoidance motion, between the teaching motions may be extracted as a target section for path generation after a sorting process. A method for sorting the teaching motions for respective robots in chronological order to satisfy the order constraints may be provided by Greedy Algorithm or Topological Sort.

### Other Embodiments

The disclosure of this specification is not limited to the illustrated embodiment. The disclosure encompasses the illustrated embodiments and variations based on the embodiments by those skilled in the art. For example, the disclosure is not limited to the combinations of components and elements shown in the embodiments, and various modifications and implementations can be performed. The disclosure may be implemented in various combinations. The disclosure may have additional portions that may be added to the embodiments. The disclosure includes the embodiments from which the parts and the components are omitted. The disclosure encompasses the replacement or combination of components, elements between one embodiment and another. The disclosed technical scope is not limited to the description of the embodiment. Technical scopes disclosed are indicated by descriptions in the claims and should be understood to include all modifications within the meaning and scope equivalent to the descriptions in the claims.

The control device and the method therefor which have been described in the present disclosure may be also realized by a dedicated computer which constitutes a processor programmed to execute one or more functions concretized by computer programs. Alternatively, the device and the method described in the present disclosure may be implemented by a dedicated hardware logic circuit. Alternatively, the device and the method thereof described in the present disclosure may be implemented by one or more dedicated computers configured by a combination of a processor that executes a computer program and one or more hardware logic circuits. Furthermore, the computer program may be stored in a computer-readable non-transitory tangible storage medium as an instruction executed by a computer.

The control device, the signal source, and the control object provide various elements. At least some of these elements may be referred to as blocks, modules, or sections. Furthermore, elements included in the control system are referred to as functional means only when intentional.

### <Disclosure of Technical Ideas>

This description discloses multiple technical ideas described in multiple sections listed below. Some sections may be presented in a multiple dependent form in which a subsequent section refers to the preceding sections selectively. Moreover, some sections may be written in a multiple dependent form referring to another multiple dependent form. These sections written in the multiple dependent form define multiple technical ideas.

### <Technical Idea 1>

A motion path generating device (1) for generating motion paths for a plurality of robots (21, 22), comprising:
a teaching motion storing unit (131) that stores teaching motions for the plurality of robots;
a constraint condition storing unit (132) that stores constraint conditions including at least an order constraint of motions for the plurality of robots;
an initial path generating unit (133) that determines motion start times of the plurality of robots based on the teaching motions and the constraint conditions and generates motion paths for the plurality of robots by generating interference avoidance paths for the plurality of robots between two of the teaching motions; and a correcting unit (134) that corrects the motion start times for the plurality of robots based on the motion paths which are generated.

### <Technical Idea 2>

The motion path generating device according to Technical Idea 1, wherein the constraint condition storing unit stores, as the constraint condition, ensuring a safety distance between the plurality of robots determined based on a distance in which one of the plurality of robots moves during an adjustable time, which is an adjustment width for one of the motion start times.

### <Technical Idea 3>

The motion path generating device according to Technical Idea 1 or Technical Idea 2, wherein the initial path generating unit generates a non-interfering path for the plurality of robots based on an adjustable time, which is an adjustment width for determined one of the motion start times.

### <Technical Idea 4>

The motion path generating device according to any one of Technical Ideas 1-3, wherein the correcting unit regenerates motions of the plurality of robots by setting the motion start time for a specific one of the plurality of robots as a fixed value.

What is claimed is:

1. A motion path generating device for generating motion paths for a plurality of robots, comprising:
a teaching motion storing unit that stores teaching motions for the plurality of robots;
a constraint condition storing unit that stores constraint conditions including at least an order constraint of motions for the plurality of robots;
an initial path generating unit that determines motion start times of the plurality of robots based on the teaching motions and the constraint conditions and generates motion paths for the plurality of robots by generating interference avoidance paths for the plurality of robots between two of the teaching motions; and
a correcting unit that corrects the motion start times for the plurality of robots based on the motion paths which are generated.

2. The motion path generating device according to claim 1, wherein
the constraint condition storing unit stores, as the constraint condition, ensuring a safety distance between the plurality of robots determined based on a distance in which one of the plurality of robots moves during an adjustable time, which is an adjustment width for one of the motion start times.

3. The motion path generating device according to claim 1, wherein
the initial path generating unit generates a non-interfering path for the plurality of robots based on an adjustable time, which is an adjustment width for determined one of the motion start times.

4. The motion path generating device according to claim 1, wherein
the correcting unit regenerates motions of the plurality of robots by setting the motion start time for a specific one of the plurality of robots as a fixed value.

5. The motion path generating device according to claim 1, further comprising:
a motion path search range setting unit which searches ranges of the motion paths based on evaluation values of the motion paths for the plurality of robots, wherein the path search range setting unit searches the motion paths for the plurality of robots so that the evaluation values for all of the plurality of robots to be controlled are equal to or less than an evaluation value for a specific one of the plurality of robot.

6. A motion path generating method which generates motion paths for a plurality of robots, the method comprising:
generating the motion paths for the plurality of robots by (i) determining motion start times for the plurality of robots based on teaching motions for the plurality of robots which are stored and constraint conditions including at least order constraints of motions for the plurality of robots which are stored and (ii) generating interference avoidance paths for the plurality of robots between two of the teaching motions; and
correcting the motion start times for the plurality of robots based on the motion paths which are generated.
